(19) United States
(12) Patent Application Publication
(10) Pub. No.: US 2020/0270467 A1
(43) Pub. Date: Aug. 27, 2020

(54) FILLER FOR CONCRETE STRUCTURES, CONCRETE STRUCTURE, AND PRODUCTION METHOD THEREFOR

(71) Applicant: DIC Corporation, Tokyo (JP)

(72) Inventors: Toru TAKEHISA, Osaka (JP); Takushi YAMAMOTO, Tokyo (JP); Takashi MATSUMOTO, Osaka (JP)

(21) Appl. No.: 16/651,300

(22) PCT Filed: Sep. 18, 2018
(86) PCT No.: PCT/JP2018/034367

§ 371 Date: Mar. 26, 2020

(30) Foreign Application Priority Data
Sep. 27, 2017 (JP) 2017-186604

(51) Int. Cl. C09D 5/34; C08K 3/34; C08L 101/14

(52) U.S. Cl. CPC C09D 5/34; C04B 41/009; C08L 101/14; C08K 3/346

(57) ABSTRACT

A filler for a concrete structure is provided. The filler includes an organic-inorganic composite hydrogel (A). The organic-inorganic composite hydrogel (A) has a three-dimensional network structure that includes a polymer of a water-soluble organic monomer and includes a water-swellable clay mineral. The filler has a water pressure resistance of 0.2 MPa or greater. The filler for a concrete structure has excellent workability and various excellent physical properties in terms of, for example, adhesion to wet surfaces and resistance to water pressure. Accordingly, the filler is suitable for use as a filler for joints and cracks of concrete structural objects.

### TECHNICAL FIELD

The present invention relates to a filler for a concrete structure and to a concrete structure, the filler having various excellent physical properties. The present invention also relates to production methods therefor.

### BACKGROUND ART

In the related art, various fillers have been proposed for joints and cracks of concrete structural objects. However, the following problems have been encountered: adhesion itself was difficult in complex shaped portions and on wet surfaces; furthermore, as a result of a failure to conform to expansion or contraction due to a seasonal variation in structural objects, delamination or brittle fracture occurred.

To address these problems, a water sealing material that retained a water-sealing function over a long period of time and was inexpensive was proposed; the water sealing material was obtained by preparing a mixture containing, as main ingredients, bentonite, a thermoplastic resin, a plasticizer, and a water-absorbent resin and molding the mixture (see PTL 1, for example). Unfortunately, the following problems were encountered: because of insufficient adhesion to wet surfaces, the water sealing material required an adhesive, and the water sealing material was not suitable for use in complex shaped portions.

Furthermore, a permeable waterproofing agent that included a surfactant, a gelling hydrophilic resin, a gelling agent, and water was proposed (see PTL 2, for example). Unfortunately, the permeable waterproofing agent presented a problem in that its resistance to water pressure was insufficient. The permeable waterproofing agent could be employed for above-ground portions of buildings. This is because in the case of leakage of water, such as rainwater, from the roof, a sidewall surface, or the like, little water pressure is exerted against waterproofing agents, and therefore resistance to water pressure is not required. On the other hand, in tunnel interiors and underpasses, which are civil engineering structures, and, in underground structures such as underground portions of buildings and underground shopping malls, ground water exerts an influence, and, accordingly, resistance to water pressure is an important property for water sealing materials. In addition, in conduits, such as water and sewage conduits, a waterproofing material is necessary as a countermeasure for leakage of water flowing through the conduits. Such waterproofing materials are also required to have resistance to water pressure.

Accordingly, there has been a need for a filler that has excellent workability and which, even in complex shapes and on wet surfaces, exhibits excellent adhesion and resistance to water pressure.

### CITATION LIST

### Patent Literature

PTL 1: Japanese Unexamined Patent Application Publication No. 2006-57275

PTL 2: Japanese Unexamined Patent Application Publication No. 11-228941

### SUMMARY OF INVENTION

### Technical Problem

Objects of the present invention are to provide a filler for a concrete structure, the filler having excellent workability and various excellent physical properties in terms of, for example, adhesion to wet surfaces and resistance to water pressure, and to provide a concrete structure in which gaps are filled with the filler. A further object is to provide production methods therefor.

### Solution to Problem

The present inventors found that a filler for a concrete structure has excellent workability and various excellent physical properties in terms of, for example, adhesion to wet surfaces and resistance to water pressure, the filler containing a specific organic-inorganic composite hydrogel. Accordingly, the present invention was completed.

Specifically, the present invention provides a filler for a concrete structure, the filler including an organic-inorganic composite hydrogel (A). The organic-inorganic composite hydrogel (A) has a three-dimensional network structure that includes a polymer of a water-soluble organic monomer and includes a water-swellable clay mineral. The filler has a water pressure resistance of 0.2 MPa or greater.

### Advantageous Effects of Invention

Fillers for a concrete structure of the present invention have excellent workability and various excellent physical properties in terms of, for example, adhesion to wet surfaces of concrete and resistance to water pressure.

Accordingly, the fillers for a concrete structure can be used as fillers for concrete structural objects, such as tunnels, roads, bridges, tracks, buildings, revetments, and water and sewage conduits, and can also be used as a repair material therefor.

### DESCRIPTION OF EMBODIMENTS

A filler for a concrete structure of the present invention includes an organic-inorganic composite hydrogel (A). The organic-inorganic composite hydrogel (A) has a three-dimensional network structure that includes a polymer of a water-soluble organic monomer and includes a water-swellable clay mineral. The filler has a water pressure resistance of 0.2 MPa or greater.

A method for producing the organic-inorganic composite hydrogel (A) may be a method in which a water-soluble organic monomer is polymerized in a dispersion (a), which includes the water-soluble organic monomer, a water-swellable clay mineral, a polymerization initiator, and water. This method is preferable because an organic-inorganic composite hydrogel having a three-dimensional network structure can be easily obtained. The resulting polymer of the water-soluble organic monomer, together with the water-swellable clay mineral, forms a three-dimensional network structure and is, therefore, a constituent of the organic-inorganic composite hydrogel (A).

Examples of the water-soluble organic monomer include, but are not limited to, (meth)acrylamide-group-containing monomers, (meth) acryloyloxy-group-containing monomers, and hydroxyl-group-containing acrylic monomers.

Examples of the (meth)acrylamide-group-containing monomers include acrylamide, N,N-dimethylacrylamide, N,N-diethylacrylamide, N-methylacrylamide, N-ethylacrylamide, N-isopropylacrylamide, N-cyclopropylacrylamide, N,N-dimethylaminopropylacrylamide, N,N-diethylaminopropylacrylamide, acryloylmorpholine, methacrylamide, N,N-dimethylmethacrylamide, N,N-diethylmethacrylamide, N-methylmethacrylamide, N-ethylmethacrylamide, N-isopropylmethacrylamide, N-cyclopropylmethacrylamide, N,N-dimethylaminopropylmethacrylamide, and N,N-diethylaminopropylmethacrylamide.

Examples of the (meth)acryloyloxy-group-containing monomers include methoxyethyl acrylate, ethoxyethyl acrylate, methoxyethyl methacrylate, ethoxyethyl methacrylate, methoxymethyl acrylate, and ethoxymethyl acrylate.

Examples of the hydroxyl-group-containing acrylic monomers include hydroxyethyl acrylate and hydroxyethyl methacrylate.

In particular, from the standpoint of solubility and the adhesion to concrete and resistance to water pressure of the resulting organic-inorganic composite hydrogel, it is preferable to use a (meth)acrylamide-group-containing monomer; it is more preferable to use acrylamide, N,N-dimethylacrylamide, N,N-diethylacrylamide, N-isopropylacrylamide, or acryloylmorpholine; it is further preferable to use N,N-dimethylacrylamide or acryloylmorpholine; and from the standpoint of promoting the progress of polymerization, N,N-dimethylacrylamide is particularly preferable.

Note that the water-soluble organic monomers mentioned above may be used alone or in a combination of two or more.

A content of the water-soluble organic monomer in the dispersion (a) is preferably 1 to 50 mass % and more preferably 5 to 30 mass %. When the content of the water-soluble organic monomer is greater than or equal to 1 mass %, a hydrogel having excellent mechanical properties can be obtained, and, therefore, such a content is preferable. On the other hand, when the content of the water-soluble organic monomer is less than or equal to 50 mass %, the dispersion can be prepared easily, and, therefore, such a content is preferable.

The water-swellable clay mineral, together with the polymer of a water-soluble organic monomer, forms the three-dimensional network structure and is, therefore, a constituent of the organic-inorganic composite hydrogel.

Examples of the water-swellable clay mineral include, but are not limited to, water-swellable smectites and water-swellable micas.

Examples of the water-swellable smectites include water-swellable hectorite, water-swellable montmorillonite, and water-swellable saponite.

Examples of the water-swellable micas include water-swellable synthetic micas.

In particular, from the standpoint of the stability of the dispersion, it is preferable to use water-swellable hectorite or water-swellable montmorillonite; it is more preferable to use water-swellable hectorite.

The water-swellable clay mineral may be a naturally occurring or synthesized clay mineral and may be a surface-modified clay mineral. Examples of the surface-modified water-swellable clay mineral include phosphonic acid-modified synthetic hectorite and fluorine-modified synthetic hectorite. From the standpoint of the adhesion to concrete and resistance to water pressure of the resulting organic-inorganic composite hydrogel, it is preferable to use phosphonic acid-modified synthetic hectorite.

Note that the water-swellable clay minerals mentioned above may be used alone or in a combination of two or more.

A content of the water-swellable clay mineral in the dispersion (a) is preferably 1 to 20 mass % and more preferably 2 to 10 mass %. When the content of the water-swellable clay mineral is greater than or equal to 1 mass %, a hydrogel having excellent mechanical properties can be synthesized, and, therefore, such a content is preferable. On the other hand, when the content of the water-swellable clay mineral is less than or equal to 20 mass %, the dispersion can be prepared easily, and, therefore, such a content is preferable.

Examples of the polymerization initiator include, but are not limited to, water-soluble peroxides and water-soluble azo compounds.

Examples of the water-soluble peroxides include potassium peroxodisulfate, ammonium peroxodisulfate, sodium peroxodisulfate, and t-butyl hydroperoxide.

Examples of the water-soluble azo compounds include 2,2′-azobis(2-methylpropionamidine) dihydrochloride and 4,4′-azobis(4-cyanovaleric acid).

In particular, from the standpoint of an interaction with the water-swellable clay mineral, it is preferable to use a water-soluble peroxide; it is more preferable to use potassium peroxodisulfate, ammonium peroxodisulfate, or sodium peroxodisulfate; and it is further preferable to use sodium peroxodisulfate or ammonium peroxodisulfate.

Note that the polymerization initiators mentioned above may be used alone or in a combination of two or more.

A molar ratio of the polymerization initiator to the water-soluble organic monomer (polymerization initiator/water-soluble organic monomer) in the dispersion (a) is preferably greater than or equal to 0.01, more preferably 0.02 to 0.1, and even more preferably 0.04 to 0.1.

A content of the polymerization initiator in the dispersion (a) is preferably 0.1 to 10 mass % and more preferably 0.2 to 10 mass %. When the content of the polymerization initiator is greater than or equal to 0.1 mass %, the organic monomer can be polymerized in an air atmosphere, and, therefore, such a content is preferable. On the other hand, when the content of the polymerization initiator is less than or equal to 10 mass %, the dispersion can be used while aggregation before polymerization is prevented, that is, handleability is improved, and, therefore, such a content is preferable.

The dispersion (a) includes a water-soluble organic monomer, a water-swellable clay mineral, a polymerization initiator, and water. The dispersion (a) may further include an organic solvent, a catalyst, an organic crosslinking agent, a preservative, a thickening agent, and the like, as necessary.

Examples of the organic solvent include alcohol compounds, such as methanol, ethanol, propanol, isopropyl alcohol, and 1-butanol; ether compounds, such as ethyl ether and ethylene glycol monoethyl ether; amide compounds, such as dimethylformamide and N-methylpyrrolidone; and ketone compounds, such as acetone and methyl ethyl ketone.

In particular, from the standpoint of the dispersibility of the water-swellable clay mineral, it is preferable to use an alcohol compound; it is more preferable to use methanol, ethanol, n-propyl alcohol, or isopropyl alcohol; and it is further preferable to use methanol or ethanol.

Note that these organic solvents may be used alone or in a combination of two or more.

The catalyst has a function of increasing the polymerization rate when the water-soluble organic monomer is polymerized.

Examples of the catalyst include, but are not limited to, tertiary amine compounds, thiosulfate salts, and ascorbic acids.

Examples of the tertiary amine compounds include N,N,N′,N′-tetramethylethylenediamine and 3-dimethylaminopropionitrile.

Examples of the thiosulfate salts include sodium thiosulfate and ammonium thiosulfate.

Examples of the ascorbic acids include L-ascorbic acid and sodium L-ascorbate.

In particular, from the standpoint of the stability of the dispersion, it is preferable to use a tertiary amine compound, and it is more preferable to use N,N,N′,N′-tetramethylethylenediamine.

Note that the catalysts mentioned above may be used alone or in a combination of two or more.

In the case where a catalyst is used, a content of the catalyst in the dispersion (a) is preferably 0.01 to 1 mass % and more preferably 0.05 to 0.5 mass %. When the content of the catalyst is greater than or equal to 0.01 mass %, the synthesis of the organic monomer for the resulting hydrogel can be efficiently promoted, and, therefore, such a content is preferable. On the other hand, when the content of the catalyst is less than or equal to 1 mass %, the dispersion can be used while aggregation before polymerization is prevented, that is, handleability is improved, and, therefore, such a content is preferable.

Examples of methods for preparing the dispersion (a) include the following: a method in which a water-soluble organic monomer, a water-swellable clay mineral, a polymerization initiator, water, and the like are mixed together collectively; and a multi-component mixing method in which a dispersion (a1), which contains a water-soluble organic monomer, and a solution (a2), which contains a polymerization initiator, are prepared separately as a dispersion and a solution, and the dispersion (a1) and the solution (a2) are mixed together immediately before use. From the standpoint of dispersibility, storage stability, viscosity control, and the like, the multi-component mixing method is preferable.

Examples of the dispersion (a1) that contains a water-soluble organic monomer include dispersions in which a water-soluble organic monomer and a water-swellable clay mineral are mixed together.

Examples of the solution (a2) that contains a polymerization initiator include aqueous solutions in which a polymerization initiator is mixed with water.

The organic-inorganic composite hydrogel can be obtained by polymerizing a water-soluble organic monomer in the dispersion (a). Methods for the polymerization are not particularly limited, and any method known in the art may be used. Specific examples include heat-induced or UV light irradiation-induced radical polymerization and radical polymerization using a redox reaction.

The polymerization temperature is preferably 10 to 80° C. and more preferably 20 to 80° C. When the polymerization temperature is higher than or equal to 10° C., the radical reaction can proceed sequentially, and, therefore, such a temperature is preferable. On the other hand, when the polymerization temperature is lower than or equal to 80° C., the polymerization can be carried out without causing boiling of the water present in the dispersion, and, therefore, such a temperature is preferable.

The polymerization time varies depending on the types of polymerization initiator and catalyst and may be tens of seconds to 24 hours. In particular, in the case of radical polymerization that uses heat or a redox, the polymerization time is preferably 1 to 24 hours and more preferably 5 to 24 hours. When the polymerization time is greater than or equal to 1 hour, the water-swellable clay mineral and a polymer of the water-soluble organic monomer can form a three-dimensional network, and, therefore, such a polymerization time is preferable. On the other hand, the polymerization reaction is nearly complete within 24 hours, and it is therefore preferable that the polymerization time be less than or equal to 24 hours.

According to the present invention, a method for producing the filler for a concrete structure may be as follows: the dispersion (a) is introduced into a gap in a concrete structure or to a surface thereof to form the organic-inorganic composite hydrogel (A) in the gap or on the surface. This method is preferable because filling can be easily accomplished even in a complex shaped portion or the like, and, therefore, workability at civil engineering sites, building construction sites, and the like is further improved.

The filler for a concrete structure of the present invention has an affinity for concrete and therefore penetrates a porous material and adheres thereto through capillary action. Furthermore, for wet surfaces, it is believed that since the filler has a high water-absorbing ability, the filler penetrates a porous material and adheres thereto in a manner such that a concentration gradient is uniform.

The filler for a concrete structure of the present invention needs to withstand the pressure of backwater due to leaking ground water or the like and the pressure of water leaking from conduits. Accordingly, it is important that the filler have a water pressure resistance of greater than or equal to 0.2 MPa; preferably, the water pressure resistance is greater than or equal to 0.3 MPa, and more preferably greater than or equal to 0.4 MPa. The upper limit of the water pressure resistance is not particularly limited. It is preferable, however, that the water pressure resistance be less than or equal to 10 MPa because in such a case, regarding expansion or contraction due to a seasonal variation in a concrete structure, the filler can flexibly conform to the concrete in close contact therewith.

In the present invention, the water pressure resistance is a water pressure resistance measured by using a method in accordance with JIS A 1404:2015, which specifies a water permeability test for architectural cement.

The filler for a concrete structure of the present invention needs to withstand the pressure of backwater due to leaking ground water or the like and the pressure of water leaking from conduits. Accordingly, it is preferable that the filler have a breaking strength of greater than or equal to 0.2 MPa; preferably, the breaking strength is greater than or equal to 0.3 MPa, and more preferably greater than or equal to 0.4 MPa. The upper limit of the breaking strength is not particularly limited. It is preferable, however, that the water pressure resistance be less than or equal to 10 MPa because in such a case, regarding expansion or contraction due to a seasonal variation in a concrete structure, the filler can flexibly conform to the concrete in close contact therewith.

In the present invention, the breaking strength is a breaking strength measured by using a method in accordance with JIS A 1439:2010, “the testing methods of sealants for sealing and glazing in buildings”, 5.20 tensile/adhesive strength test.

The filler for a concrete structure of the present invention has excellent adhesion to wet surfaces of concrete and excellent resistance to water pressure. Reasons for this are not necessarily clear. One speculation is that since the organic-inorganic composite hydrogel according to the embodiment, which has excellent hydrophilicity, fills porous portions present in a surface of concrete in a gapless manner, the area of contact between the concrete and the organic-inorganic composite hydrogel is greatly increased, that is, an “anchoring effect” is produced.

The filler for a concrete structure of the present invention has excellent workability, is flame retardant, and has various excellent physical properties in terms of, for example, adhesion to wet surfaces of concrete and resistance to water pressure. Accordingly, the filler for a concrete structure can be used as a filler for concrete structural objects, such as tunnels, roads, bridges, tracks, buildings, revetments, and water and sewage conduits, and can also be used as a repair material therefor.

### EXAMPLES

The present invention will now be described in more detail with reference to specific examples.

### Example 1

20 g of N,N-dimethylacrylamide (hereinafter abbreviated as “DMAA”), 4.8 g of water-swellable synthetic hectorite (Laponite-RD, manufactured by BYK Japan KK), and 100 g of pure water were mixed together and stirred. Thus, a dispersion (a1-1) was prepared. Furthermore, 0.5 g of sodium peroxodisulfate (hereinafter abbreviated as “NPS”) and 10 g of pure water were mixed together and stirred. Thus, an aqueous NPS solution (a2-1) was prepared. Furthermore, 80 μL of N,N,N′,N′-tetramethylethylenediamine (hereinafter abbreviated as “TEMED”) and 10 g of pure water were mixed together and stirred. Thus, a homogeneous aqueous TEMED solution was prepared. Next, the dispersion (a1-1) and the aqueous NPS solution (a2-1) were mixed together such that a mass ratio [(a1-1)/(a2-1)] was 10. Thus, a dispersion (a-1) was obtained.

### [Evaluation of Adhesion to Wet Surfaces]

Two mortar slabs (50 mm×50 mm×10 mm) were immersed in water in advance, for 24 hours at room temperature. After the mortar slabs were taken out, water droplets adhering to the surfaces were lightly wiped off. The two mortar slabs were arranged such that the 50 mm×50 mm surfaces were parallel to each other. Two polypropylene spacers having a width of 12 mm were inserted between the mortar slabs. The two spacers were spaced apart from each other at a distance of 12 mm, and thus a space to be filled by the hydrogel was created. The mortar slabs and the spacers were entirely fixed with aluminum tape. Next, the total amount of aqueous TEMED solution, which was prepared as described above, was mixed with 110 g of the dispersion (a-1), which was prepared as described above. The mixture was thoroughly stirred and subsequently filled into the space between the two pieces of mortar. The resultant was left to stand for 24 hours, and as a result, a tough hydrogel was formed. Thus, a filler for a concrete structure, together with a mortar-gel-mortar structure, was obtained. The structure was subjected to a tensile test in accordance with JIS A 1439:2010, “the testing methods of sealants for sealing and glazing in buildings”. Adhesion to wet surfaces was evaluated according to the following criteria.

A: 0.4 MPa or greater

B: 0.2 MPa or greater and less than 0.4 MPa

C: less than 0.2 MPa or unmeasurable because gel was brittle

### [Evaluation of Resistance to Water Pressure]

The total amount of aqueous TEMED solution was mixed with 110 g of the dispersion (a-1). The mixture was thoroughly stirred and subsequently filled into a hollow portion of a concrete cylinder, which was a cylinder having a diameter of 100 mm and a thickness of 100 mm and in which a central portion having a diameter of 26 mm was hollow. The resultant was left to stand for 24 hours, and thus a filler for a concrete structure, together with a gel-concrete structure, was obtained. The structure was subjected to a measurement, which was performed using a method in accordance with JIS A 1404:2015, which specifies a water permeability test for architectural cement. Specifically, pressure was applied with water to the entire top surface of the cylinder, and the water pressures at which no ingress of water occurred in the bottom surface of the cylinder while no breakage of the gel occurred were measured. Evaluations were made according to the following criteria.

A: 0.4 MPa or greater

B: 0.2 MPa or greater and less than 0.4 MPa

C: less than 0.2 MPa or unmeasurable because gel was brittle

### Example 2

A dispersion (a1-2) was prepared as in Example 1 except that instead of DMAA, acryloylmorpholine (hereinafter abbreviated as “ACMO”) was used as a water-soluble organic monomer. Subsequently, a filler for a concrete structure, together with a mortar-gel-mortar structure, was prepared. Adhesion to wet surfaces and resistance to water pressure were evaluated.

### Example 3

A dispersion (a1-3) was prepared as in Example 1 except that instead of Laponite-RD, phosphonic acid-modified synthetic hectorite (Laponite-RDS, manufactured by BYK Japan KK) was used as a water-swellable clay mineral. Subsequently, a filler for a concrete structure, together with a mortar-gel-mortar structure, was prepared. Adhesion to wet surfaces and resistance to water pressure were evaluated.

### Example 4

A dispersion (a1-4) was prepared as in Example 1 except that instead of DMAA, ACMO was used as a water-soluble organic monomer, and instead of Laponite-RD, phosphonic acid-modified synthetic hectorite (Laponite-RDS, manufactured by BYK Japan KK) was used as a water-swellable clay mineral. Subsequently, a filler for a concrete structure, together with a mortar-gel-mortar structure, was prepared. Adhesion to wet surfaces and resistance to water pressure were evaluated.

### Comparative Example 1

20 g of DMAA, 0.5 g of NPS, and 100 g of pure water were mixed together and stirred. Thus, a homogeneous solution was prepared. Furthermore, 80 μL of TEMED was added to the homogeneous solution, and these were mixed together and stirred. The resultant was left to stand at room temperature. As a result, an aqueous poly(N,N-dimethylacrylamide) solution was obtained. 4.8 g of Laponite-RD and the aqueous solution were mixed together and stirred. As a result, a white viscous suspended liquid (r-1) was obtained. The viscous liquid (r-1) was filled into a space between two pieces of mortar as in Example 1, and, 24 hours later, an examination was performed. It was found that a very weak, jelly-like gel was formed. When the two pieces of mortar were held in hands and slightly stretched, the gel immediately broke. Thus, it was impossible to measure the adhesion of the gel to the concrete. Furthermore, the viscous liquid (r-1) was filled into a hollow concrete cylinder and was left to stand for 24 hours, as in Example 1. It was found that a very weak, jelly-like gel was formed in the hollow portion. When the gel was lightly pushed with a glass rod, the gel easily broke. Thus, it was impossible to measure the resistance to water pressure of the obtained gel.

The evaluation results of Examples 1 to 4 and Comparative Example 1 are shown in Table 1.

TABLE 1

| | Example | Example | Example | Example | Comparative |
|---|---|---|---|---|---|
| Table 1 | 1 | 2 | 3 | 4 | Example 1 |
| Water-soluble | DMAA | ACMO | DMAA | ACMO | Mixture of DMAA |
| organic monomer | | | | | polymer and RD |
| Water-swellable | RD | RD | RDS | RDS | |
| clay mineral | | | | | |
| Adhesion to wet | A | A | B | B | C |
| surfaces | 0.4 | 0.4 | 0.35 | 0.3 | Unmeasurable |
| (MPa) | | | | | |
| Resistance to | A | A | B | B | C |
| water pressure | 0.5 | 0.4 | 0.3 | 0.3 | Unmeasurable |
| (MPa) | | | | | |

It was confirmed that the filler for a concrete structure of Example 1, which was in accordance with the present invention, had excellent adhesion to wet surfaces and resistance to water pressure.

On the other hand, in Comparative Example 1, in which a mixture of a water-swellable clay mineral and a polymer of a water-soluble organic monomer was used, the toughness of the gel was significantly degraded, and it was impossible to evaluate the adhesion to wet surfaces and resistance to water pressure.

1. A filler for a concrete structure, the filler comprising an organic-inorganic composite hydrogel (A), the organic-inorganic composite hydrogel (A) having a three-dimensional network structure that includes a polymer of a water-soluble organic monomer and includes a water-swellable clay mineral, the filler having a water pressure resistance of 0.2 MPa or greater.

2. The filler for a concrete structure according to claim 1, wherein essential materials from which the organic-inorganic composite hydrogel (A) is formed include a water-soluble organic monomer, a water-swellable clay mineral, a polymerization initiator, and water.

3. A concrete structure in which the filler for a concrete structure according to claim 1 fills a gap in a concrete structural object or is disposed on a surface of the concrete structural object.

4. A method for producing the filler for a concrete structure according to claim 1, the method comprising forming the organic-inorganic composite hydrogel (A) in a gap in a concrete structural object or on a surface of the concrete structural object.

5. A method for producing a concrete structure, the method comprising filling a gap in a concrete structural object with the filler obtained by using the method according to claim 4.
